(19) United States
(12) Patent Application Publication
(10) Pub. No.: US 2022/0009666 A1
(43) Pub. Date: Jan. 13, 2022

(54) PLASTIC CONTAINER

(71) Applicant: ALPLA WERKE ALWIN LEHNER GMBH & CO. KG, Hard (AT)

(72) Inventor: Robert Siegl, Dornbirn (AT)

(21) Appl. No.: 17/292,691

(22) PCT Filed: Nov. 5, 2019
(86) PCT No.: PCT/EP2019/080166

§ 371 Date: May 10, 2021

(30) Foreign Application Priority Data
Nov. 9, 2018 (CH) 01384/18

(51) Int. Cl. B65D 1/02; B29C 49/08; B29C 49/00; B29C 49/42; B65D 23/10

(52) U.S. Cl. CPC B65D 1/023; B29C 49/08; B29K 2067/003; B29C 49/4278; B65D 23/10; B29C 49/0005

(57) ABSTRACT

The invention relates to a plastic container which is stretch blow-molded from a preform and which comprises a container body having a container neck attached thereto, on which container neck there is provided an outlet opening, wherein the container body has a second opening closed by a weld seam. The container is made from a copolyester. The wall of the stretched container body has a stretching ratio relative to the wall of the unstretched container neck in the region of the at least one weld seam of more than 6:1. After the welding, the stretched container body has a density increase relative to the unstretched container neck in the region of the at least one weld seam of less than 0.06 g/cm³.

### CROSS-REFERENCE TO RELATED APPLICATIONS

This application is a national phase entry under 35 U.S.C. § 371 of PCT/EP2019/080166 filed Nov. 5, 2019, which claims priority to Swiss Patent Application No. 01384/18 filed Nov. 9, 2018, the entirety of each of which is incorporated by the reference.

### Field of the Invention

The invention relates to a plastic container which is stretch blow-molded from a preform, a method for producing a plastic container manufactured from a preform, and the use of a copolyester for producing a preform.

### Prior Art

Tubes and containers having an integrally formed handle (handle containers) are known in the prior art, being made from plastic. The plastic must be weldable in order to produce tubes or handle containers. Therefore, tubes and handle containers are often made from HDPE (High Density Polyethylene), since HDPE is readily weldable. However, the barrier properties of HDPE are so poor, especially with regard to oxygen, that these containers are usually unsuitable for the packaging of foodstuffs. By the use of multilayered structures, the barrier property of HDPE can be raised to a degree necessary for foodstuffs, but multilayered structures are undesirable in plastics recycling, because they make the recycling process expensive or sometimes even impossible for recycling.

In the case of tubes, a weld seam is used in order to close the end of the tube facing away from the tube body, after the tube has been filled with contents. In the case of handle bottles, a basic shape of the container is produced for example by blow molding. A reach-through opening is cut out or punched out from the blow-molded container and the reach-through opening is welded at its periphery. In this way, the container has a handle with a welded and accordingly sealed reach-through opening.

It would be desirable to produce tubes and handle containers from PET (polyethylene terephthalate), since PET containers can be produced as a single-layer container and used in the food industry on account of the good barrier property of PET with respect to oxygen. Furthermore, PET containers can be made highly transparent, which is often desirable in packages for stylistic reasons. Containers made from PET are usually stretched (forming a stretch crystallization or a crystallization by stretching), since they are usually made from a preform by the stretch blow-molding process. The stretching process results in a partial crystallization of the material. However, stretched, partly crystalline PET is poorly weldable and therefore not sufficiently dependable for welding. This holds in particular for “standard” PET. In the context of this patent application, “standard” PET shall mean a PET having a viscosity between 0.72 and 0.88 dl/g per ASTM D4603 and a copolymer content under 4 wt. % (percent by weight).

Special PET forms, such as PET with “long chain branching”, are in use for the manufacturing of handle containers. However, these special PET forms are costly, have limited recycling ability, can only be processed on special costly machines, and do not always possess the needed barrier properties.

Stretched PET at room temperature exists in a kind of frozen, prestressed state and it contracts when heated above the glass transition point. This tendency to move complicates the welding of stretched PET, since any movement will disrupt the welding process. Therefore, the parts being welded together need to be prevented from contracting by the use of holding fixtures, so as not to move relative to each other or to the welding dies. The retention of the PET parts results in a “frozen” stress in the weld seams, which weakens them and may serve as the starting point for stress cracks.

A heat treatment between the glass transition point (T_{G}) and the melting point (T_{M}) of the PET additionally results in further undesirable crystallization phenomena. Crystalline surfaces adhere poorly to one another. A welding of standard PET between the T_{G} and the T_{M} is not strong enough to withstand the usual stresses of tubes or handle containers.

The desired properties of stretch crystallization, making the stretched regions of the PET stronger, more flexible, and more tough, are entirely disrupted when welding is done above the T_{M}. A stable welded connection could be produced by fusion above T_{M}, but the stretching or the stretch crystallization and thus the orientation of the molecules is abolished. This means that the weld seam after the heating above T_{M} is crystallized either amorphously or spherulitically. In either case, a weld seam in the area of such a crystallized PET is more fragile than a weld seam of stretched PET produced at a temperature below T_{M}, and therefore it is not suitable for a flexible packaging.

### Problem of the Invention

The problem of the present invention is therefore to indicate stretch blow-molded plastic containers made from a copolyester which have the advantages of a stretched container, the walls of which can nevertheless be joined by a welded connection, said welded connection standing up to the usual stresses of plastic containers. This holds in particular for tubes or handle containers, since welded connections are usually unavoidable during their manufacture. Furthermore, in particular a tube is to be created which is suitable for containing foodstuffs but nevertheless is readily recyclable.

### SUMMARY OF THE INVENTION

The solution of the stated problem is achieved fora plastic container which is stretch blow-molded from a preform according to the independent claims. Further developments and/or advantageous variant embodiments are the subject matter of the dependent claims.

A container is made from a copolyester, the wall of the stretched container body has a stretching ratio relative to the wall of the unstretched container neck in the region of the at least one weld seam of more than 6:1, and after the welding, the stretched container body has a density increase relative to the unstretched container neck in the region of the at least one weld seam of less than 0.06 g/cm³.

In the context of this application, stretching shall mean the biaxial expansion of the wall surface of the preform towards the wall surface of the container body.

In the context of this application, a welded connection or a weld seam shall mean a connection which joins together surfaces unreleasably by application of heat and pressure.

The invention makes it possible to connect openings on a stretch blow-molded plastic container made from a preform with a weld seam in surprisingly good and firm manner by fulfilling certain properties of the production material, a certain stretching ratio in the region of the weld seam and a certain density increase in the region of the weld seam. Because the density increase of the stretched container body in the region of the weld seam remains below 0.06 g/cm³, the crystallization remains below 40%. The density increases proportionately with the crystallization and may therefore be used as a measure of the crystallization. The density increase or the increase in the crystallization occurs due to the stretching of the preform and in addition due to the spherulitic crystallization during the welding or the producing of the weld seam. If the stated density increase is obeyed, the weld seam will be sufficiently flexible and not fragile. The stated high stretching ratio does not result in a fragile weld seam if the measure of the crystallization caused by the stretching is not too high. A high stretching ratio is desirable in order to obtain a stable plastic container. The material of the container body is readily weldable and the weld seam passes the typical stress tests to verify flexibility and stability. The plastic container made from copolyester needs no further barrier layers in order to have a sufficient oxygen barrier. The container is therefore readily recyclable, since it consists of a pure-grade copolyester.

In one embodiment of the invention, the copolyester is polyethylene terephthalate (PET) having a copolymer content between 4 wt. % and 10 wt. %, wherein the copolymer is isophthalic acid, diethylene glycol, furan dicarboxylic acid, propylene glycol or butylene glycol. Thanks to the proportion of the copolymer content being between 4 wt. % and 10 wt. %, the measure of the crystallization can be kept below 20%, even though the stretching ratio is very high, being more than 6:1. The container possesses the good oxygen barrier of PET, it can be transparent, it is recyclable being of pure-grade, and its material is readily weldable. The material is very readily weldable below the melting point, so that the orientation of the PET achieved by the stretching is not lost in the region of the weld seam during the welding.

In another embodiment of the invention, the copolyester is polyethylene furanoate (PEF) having a copolymer content below 5 wt. %, wherein the copolymer is terephthalic acid, isophthalic acid or diethylene glycol, propylene glycol, spiroglycol or butylene glycol. It has been discovered for PEF that even a copolymer content of less than 5 wt. % is possible, since PEF crystallizes slowly. Therefore, a crystallization of under 20% is possible for PEF with a reduced polymer content, even if the stretching ratio is more than 6:1. The container possesses all the advantages of PEF, especially the good recyclability and the possibility of producing it from renewable raw materials. In addition, the material of the container is very readily weldable below the melting point.

It has proven to be advantageous when the stretched container body prior to welding shows a density increase relative to the unstretched container neck of less than 0.03 g/cm³ in the region of the at least one weld seam. The stated density increase corresponds to a crystallization of under 20%. With a density increase of less than 0.03 g/cm³, the copolyester is very readily weldable below the melting point. The controlled density increase can be steered through the copolymer content, especially the copolymer content of PET or PEF.

It should be noted that a definite determination of the degree of crystallization is difficult and depends on the measurement method chosen. The most common methods for determination of the degree of crystallization in the case of polymers are densitometry, calorimetry (DSC), X-ray diffraction, infrared spectroscopy, or nuclear resonance spectroscopy. Therefore, for purposes of this application, a density increase of 0.03 g/cm³ shall correspond to a degree of crystallization of 20% and a density increase of 0.06 g/cm³ shall correspond to a degree of crystallization of 40%.

In another embodiment, the container is a tube having a tube neck and a tube end lying opposite the tube neck, while the outlet opening is situated in the region of the tube neck and the second opening is situated in the region of the tube end and the second opening is sealed by the weld seam. The invention makes it possible for a tube to be produced from a PET or PEF based copolyester and still have a stable weld seam which passes the usual stress tests. The tube is suitable for the packaging of foodstuffs, since PET or PEF possesses a good oxygen barrier and is very readily recyclable, because the PET or the PEF is pure-grade and the tube material is lacking in further barrier layers.

In another embodiment of the invention, the container has an integral handle formed with a reach-through opening, wherein the weld seam bounds off the reach-through opening by joining a first and second wall end bordering on the reach-through opening. The invention makes it possible to produce a handle container from a PET or PEF based copolyester, having a stable and tight weld seam around the reach-through opening. The handle container is suitable for the packaging of foodstuffs, such as milk or fruit juice, since PET or PEF possesses a good oxygen barrier and is very readily recyclable, because the PET or the PEF is pure-grade and the container material is lacking in further barrier layers.

It is also possible for the plastic container and especially the handle container to be transparent so that the level of contents can be identified at all times.

Expediently, the weld seam having a length of 5 mm can withstand a tensile force of at least 100 N, the tensile force being oriented substantially perpendicular to the weld seam. This strength of the weld seam makes it possible for the weld seam to be sufficiently stable to close and seal an opening, especially for tubes or handle containers. The weld seam is mechanically stressable and does not become brittle or leaky during the use of the container.

The container may be designed as a single layer for an easier recycling process. Since PET or PEF has a good oxygen barrier, the container is lacking in further layers serving as barrier layers or coatings. The container is pure-grade and as such can be more easily recycled.

Expediently, the PET or the PEF for manufacturing the container is bio-based in a proportion of at least 30%. In this way, the plastic container can be produced at least for a portion from renewable raw materials. For the production making use of PEF, this can be fructose or glucose, for example. Alternatively, a proportion of at least 30% regenerate is possible.

In another embodiment of the invention, the second opening of the container is closed by forming a weld seam in a temperature range situated above the glass temperature (T_{G}) and below the melting temperature (T_{M}) of the copolymer. The choice of the welding temperature in this temperature range results in a weld seam which is sufficiently stable, since the density of the wall in the region of the weld seam prior to the welding is below 0.03 g/cm³ and therefore its formation is not too crystalline. A welding temperature above T_{M} can be avoided, which brings along the major advantage that the material properties achieved by the stretching are not lost. Furthermore, the weld seam after heating above T_{M} cools down either amorphously or spherulitically. In either case, such a crystallized PET is more fragile than stretched PET and therefore it is unsuitable for a flexible packaging.

A further aspect of the invention relates to a method for manufacturing a plastic container which is produced from a preform, wherein the preform being produced from copolyester and being stretched in a stretch blow-molding process. The method comprises the following manufacturing steps:
stretch blow-molding of the preform, during which walls of the preform are enlarged respectively by at least 6 times relative to the unstretched state at least in the region where a weld seam is produced and the density of the walls in the stretched region is increased by at most 0.03 g/cm³,
pressing together the stretched walls, and
welding the walls together to form the weld seam at a welding temperature between the glass transition temperature and the melting temperature of the copolyester. By maintaining the density increase below 0.03 g/cm³ and a welding temperature between T_{G} and T_{M}, a stable weld seam can be produced, even with a stretching ratio of more than 6:1.

Because of the fact that the density of the walls in the region of the weld seam is increased by at most 0.06 g/cm³ due to the welding, it is assured that the weld seam is not brittle or fragile. Therefore, the welding parameters such as temperature, holding time, heating rate and cooldown rate are to be chosen such that the claimed density increase in the region of the weld seam is not exceeded.

It has proven to be advantageous when an integral handle with a reach-through opening is formed on the container and when the weld seam bounds off the reach-through opening by joining together walls bordering on the reach-through opening. In this way, it is possible to produce a handle container from a copolyester which is PET or PEF based. The handle container can be used to contain foodstuffs, since it has a sufficient oxygen barrier.

In another embodiment of the invention, a portion of the container is severed or cut off prior to the pressing together and welding together, thereby producing an opening, and this opening is closed during the forming of the weld seam at a welding temperature between the glass transition temperature and the melting temperature of the copolyester. In this way, the container can be filled through the opening and after the filling, it can be closed by the weld seam. Other openings serving for grasping or holding the container can also be welded on its periphery, so that the container can be sealed once more after cutting out the opening.

It has proven to be advantageous when the welding time during which the walls are held at welding temperature is between 1 and 6 seconds. In this way, the walls are heated for a sufficient time to adhere firmly to each other and to produce a sufficiently stable and flexible weld seam.

The walls may be welded together between a first and a second welding jaw, the pressing force against the walls being between 50 and 50000 N/cm2. Thanks to this range of pressing force, a sufficiently firm adherence between the walls can be produced, while avoiding a density increase which would weaken the weld seam.

A further parameter regarding the welding process is that the welding jaws are opened at a cooldown temperature, said cooldown temperature being below the glass transition temperature. Thus far in the prior art it has not been possible to produce a sufficiently firm weld seam for joining the walls of such a container.

The copolyester may be polyethylene terephthalate (PET) having a copolymer content between 4 wt. % and 10 wt. %. Thanks to this composition, the density increase of a PET-based copolyester after the stretching can be kept below 0.03 g/cm³ and the crystallization can be kept below 20%, even though the wall is stretched by more than 6 times relative to the unstretched state. These parameters result in the welded walls being sufficiently firmly joined together.

The copolyester may be polyethylene furanoate (PEF) having a copolymer content below 5 wt. %. Thanks to this composition, the density increase of a PEF-based copolyester after the stretching can be kept below 0.03 g/cm³ and the crystallization can be kept below 20%, even though the wall is stretched by more than 6 times relative to the unstretched state. These parameters result in the welded walls being sufficiently firmly joined together.

Advantageously, the preform is stretch blow-molded in a corresponding blow mold for the production of a tube, after stripping from the mold the closed tube end situated opposite the tube neck is cut off, the tube is optionally filled with contents through the second opening formed by cutting off the tube end, and the second opening is closed by welding. This makes possible, in surprising manner, the production of a tube even though its opening is not weldable according to the prior art, since the tube is stretch blow-molded in a standard process and made from a copolyester, such as PET or PEF. The tube is suitable for containing foodstuffs, since it has a sufficient oxygen barrier and can be recycled in pure-grade manner, being free of additional barrier layers.

A further aspect of the invention relates to a method for producing of a connection between stretched walls of a plastic container made from copolyester or of plastic containers made from copolyester according to the above specification. The above specified parameters regarding the welding of the walls and the above specified properties regarding the container or the copolyester make possible the production of a sufficiently stable weld seam for the connection of the stretched walls.

Yet another aspect of the invention relates to the use of a copolyester for production of a preform in order to manufacture a container from this preform in a stretch blow-molding process, wherein the container comprises a container body and a container neck attached thereto, having an outlet opening, and wherein the container has a second opening closed by a weld seam.

The copolyester is polyethylene terephthalate (PET) having a copolymer content between 4 wt. % and 10 wt. % or in that the copolyester is polyethylene furanoate (PEF) having a copolymer content below 5 wt. %. These compositions of the copolyester make it possible for the density increase after completion of the stretch blow-molding process to remain below 0.03 g/cm3, so that the crystallization can be kept low and the walls can therefore be readily welded together.

In another embodiment of the invention, the surface of the container in the region of the at least one weld seam has a stretching ratio relative to the surface of the preform of more than 6:1 and the container body after the welding has a density increase in the region of the at least one weld seam of less than 0.06 g/cm³ relative to the preform body. This low density increase means that the crystallization in the region of the weld seam remains below 40% and the weld seam is not brittle or fragile, but instead the second opening is closed up sufficiently tight and firm.

In another embodiment of the invention, the copolyester is polyethylene terephthalate (PET) having a copolymer content between 4 wt. % and 10 wt. %, wherein the copolymer is isophthalic acid, diethylene glycol, furan dicarboxylic acid, propylene glycol, or butylene glycol.

In another embodiment of the invention, the copolyester is polyethylene furanoate (PEF) having a copolymer content below 5 wt. %, wherein the copolymer is terephthalic acid, isophthalic acid or diethylene glycol, propylene glycol, spiroglycol or butylene glycol.

The choice of the copolymer can be used to give the container certain material properties required for its use. The walls of the container remain weldable as long as the stated copolymer content is observed.

### BRIEF DESCRIPTION OF THE DRAWINGS

Further advantages and features will emerge from the following description of two exemplary embodiments of the invention, making reference to the schematic representations. There are shown, not being drawn true to scale, in:

FIG. 1: 4 method steps of producing a tube from a preform;

FIG. 2: a representation of the producing of a plastic container with handle from a preform;

FIG. 3: a representation of a first sample type for determining the tensile strength of a weld seam on a plastic container, and

FIG. 4: a representation of a second sample type for determining the tensile strength of a weld seam on a plastic container.

### DETAILED DESCRIPTION OF THE INVENTION

The present invention relates to a plastic container. The plastic container is a tube 11 or a container (handle container 13) having an integrally formed handle 15. The container has at least one weld seam 17 and is stretch blow-molded from a preform 19. The plastic container (tube 11, handle container 13) comprises a container body 21 and a container neck 23 adjacent to the container body 21. The container body 21 has a wall 25 enclosing a cavity 27. The container neck encloses an outlet opening 29. Through the outlet opening 29, the contents placed in the plastic container can be removed.

The invention makes it possible, in surprising manner, for a first and a second wall end 39a, 39b or a second opening 40 of the container to be sufficiently firmly weldable, so that the weld seam 17 passes the prescribed strength tests. This is so even though the container is produced according to a standard stretch blow-molding process from a preform 19 and consists of a copolyester. In this way, it is possible to stretch blow-mold a tube 11 or a handle container 13 from a preform, consisting of PET or PEF, the wall ends of which need to be welded or a second opening needs to be welded.

In the standard stretching process, the preform 19 is placed in a blow mold 31, the container neck 23 remaining outside the blow mold 31. The preform 19 comprises a preform body 20 and a preform neck 22. The preform is usually heated to the required processing temperature before being placed in the blow mold 31. Through the outlet opening 29, a blowing lance is introduced into the preform 19, stretching the preform 19 by a particular amount in the axial direction. The preform is then blown with a gas, which is blown in through the blowing lance, and further stretched radially and axially, until the wall 25 lies against the blow mold 31. After the cooldown of the produced container, it can be removed from the blow mold 31. The container neck 31 may also have an external thread 33, by which a closure cap having a corresponding internal thread can be screwed onto the container neck 23.

In order to connect the wall ends 39a, 39b by a weld seam 17, or to close the second opening 40 by the weld seam 17, the stretch blow-molded material of the container must have certain properties. Otherwise, the weld seam 17 might not fulfill the strength requirements, especially those involving a container in which foodstuffs are packaged.

The first and the second wall end can be welded between the glass transition temperature T_{G} and the melting temperature T_{M} of the copolyester. Below the glass transition temperature, no welded connections can be produced, since these temperatures are too low. Above the melting temperature, the strength properties achieved by the stretching of the preform 19 are lost. This includes the lost stretch crystallization. Furthermore, the weld seam 17 after the heating above T_{M} cools down to crystallize either amorphously or spherulitically. In either case, such a crystallized PET is more fragile than stretched PET and therefore it is unsuitable for a flexible packaging. By stretch crystallization is meant that the stretching can bring molecules so close to each other that they can bring about intermolecular interactions with each other. These interactions are responsible for an adhesion between the molecules, making the container stronger, more flexible, and more tough. A welding of copolyesters is possible above the glass transition temperature, since molecular entanglements or adhesions with molecules between the partly crystalline zones may form as a result of the chain mobility occurring in this temperature range.

The welding of the copolyester in the above specified temperature range results in a sufficiently firm weld seam 17 when the wall of the container body has been stretched by at least 6 times relative to the wall of the preform body 20. It is understood that this stretching ratio must be present in particular in the region of the weld seam 17.

In order for the weld seam 17 to have a sufficient stability after the cooldown, the stretch crystallization in the region of the weld seam 17 should not be more than 20% prior to the welding. In combination with the welding conditions defined further below, one can prevent the material of the weld seam from having a crystallization of more than 40% and becoming fragile. This can be achieved in that the proportion of copolymers in the copolyester has a certain value. For PET, it has been found that the proportion of the copolymers between 4 wt. % and 10 wt. % is especially suitable for keeping the crystallization (the degree of crystallization) low. For PEF, the proportion of less than 5 wt. % of copolymers is especially suitable.

Since the crystallization is idealized from 0% to 100%, in the context of this application the values for the density increase are indicated in place of the crystallization, since a heightened crystallization goes hand in hand with an increased density. The density of the preform body 20 will be compared to the density of the container body 21 or that of the unstretched container neck 23. A crystallization of 20% corresponds to a density increase of the container body by 0.03 g/cm³ as compared to the preform body 20 or the unstretched container neck 23. That is, the density of the container body 21 without the container neck 23 has increased by 0.03 g/cm³ as compared to the density of the preform body 20 without the preform neck 23. A crystallization of 40%, which the material of the weld seam falls short of, corresponds to a density increase of 0.06 g/cm³ as compared to the preform body 20 or the unstretched container neck 23.

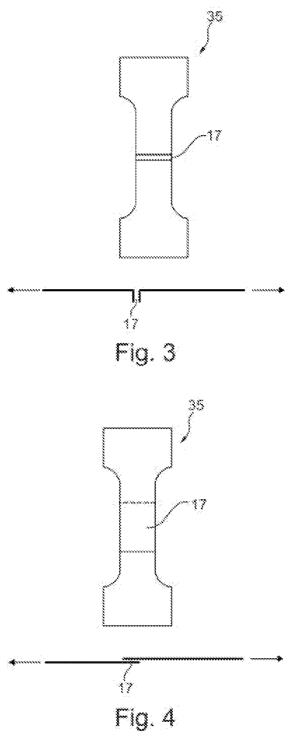

In order to determine the optimal welding conditions for producing a durable and nonbrittle weld seam 17, wall samples 35 are cut out from the wall 25 of the stretched container body 21. The sample 35 has a width of 12 mm at its opposite ends. In the middle of the sample 35, the width narrows to 5 mm. The sample 35 therefore has the shape of a bone. In the middle of the sample, the sample is cut apart across its lengthwise dimension. The two resulting sample pieces are joined together again with a weld seam 17. The parameters for producing the weld seam are varied in order to optimize the strength of the weld seam 17. Besides the duration of the welding time ₛ, the value of the welding temperature Tₛ and the cooldown temperature T_{C}, the nature of the weld seam is also varied. FIG. 3 shows a butt type weld seam 17, while FIG. 4 shows an overlapping weld seam 17. The butt-type weld seam has a maximum peeling stress and the overlapping weld seam has a maximum shear stress.

After producing the weld seam 17, the wall sample 35 is subjected to a tensile test, the ends being clamped in a tensioning device. The weld seam is oriented 90 degrees +/−5 degrees toward the tensioning direction. Both the butt type and the overlapping weld seam 17 are sufficiently strong when sustaining 100 N of tensile force. The tensile force was applied to the wall sample by the tensioning device with a longitudinal speed of 100 mm/min.

As already mentioned further above, a welding temperature T_{S} results in a sufficient strength of the weld seam 17, being between the glass transition temperature T_{G} and the melting temperature T_{M}. For PET copolymers, this temperature range is between 170° C. and 220° C. For PEF and PEF copolymers, this temperature range is between 120° C. and 210° C. A sealing time t_{S} of 3 seconds, being the time when the welding jaws weld together the first and second wall end with the sealing temperature T_{S}, proves to be optimal. The cooldown temperature T_{C} at which the welding jaws are opened once more is below T_{G}. The pressing force of the welding jaws against the first and second wall ends is between 50 and 50000 N/cm².

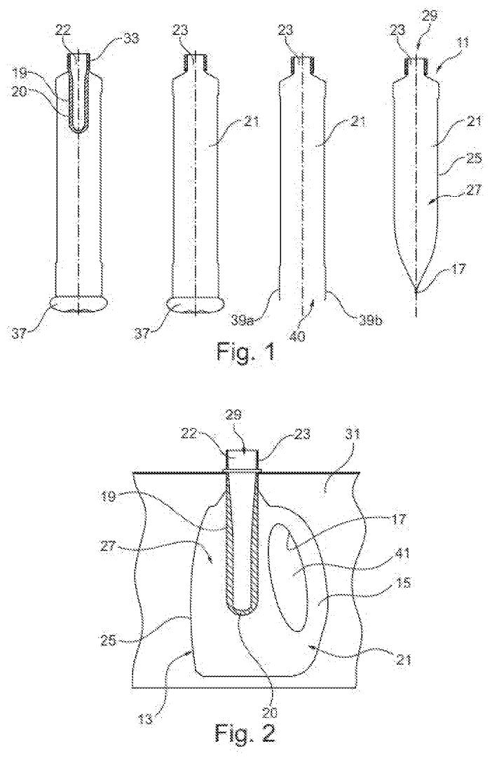

FIG. 1 shows the production of the tube 11 from the preform 19. The preform is placed in the blow mold, with the preform neck 22 remaining outside the blow mold. After stretching, blowing, and removal of the resulting plastic container, as already described further above, the container has a bottom or a tube end 37, which is no longer needed. The tube end 37 is cut off and can therefore also be considered to be a “lost” tube end. There are formed a first and second wall end 39a, 39b, which need to be permanently joined together by the weld seam 17, or the second opening 40 needs to be closed by the weld seam 17. Typically, the tube 11 can be filled with contents prior to the closure by the weld seam 17. The lost tube end is generally recycled within the production operation.

The weld seam 17 is produced according to the above welding parameters. Stress tests have shown that the weld seam 17 can sustain a dropping of the tube 11 onto the weld seam from a height of 2 m. After 20 repetitions of bending of the weld seam 17 across a pipe with a diameter of 30 mm, the weld seam 17 still remains tight. A kinking of the weld seam does not result in any leakage of the weld seam, either. Such a tube 11 therefore fulfills the stress requirements which must be met by tubes of the prior art.

FIG. 2 shows the production of the handle container 13 from the preform 19. After producing a container by the standard stretch blowing process, as described further above, a reach-through opening 41 is cut or punched out from the container. This produces a first and second wall end, which surround the reach-through opening or a second opening. In order to seal the handle container once more along the reach-through opening, the first and the second wall end must be welded together to form the weld seam 17 or the second opening must be closed. In order for the weld seam 17 to be sufficiently stable, this is produced by obeying the above specified welding parameters.

1. A copolyester container that is stretch blow-molded from a preform comprising:
a stretched container body having a container neck attached thereto, the container neck having an outlet opening, and the container body having a second opening closed by a weld seam;
a container wall of the stretched container body having a stretching ratio relative to a neck wall of the unstretched container neck in a region of the weld seam of more than 6:1; and
the stretched container body having greater density relative to the unstretched container neck in the region of the weld seam of less than 0.06 g/cm³ after welding.

2. The container according to claim 1, wherein the copolyester of the container is polyethylene terephthalate (PET) having a copolymer content between 4 wt. % and 10 wt. %, and the copolymer comprises isophthalic acid, diethylene glycol, furan dicarboxylic acid, propylene glycol, or butylene glycol.

3. The container according to claim 1, wherein the copolyester of the container is polyethylene furanoate (PEF) having a copolymer content below 5 wt. %, wherein the copolymer is terephthalic acid, isophthalic acid or diethylene glycol, propylene glycol, spiroglycol or butylene glycol.

4. The container according to claim 1, wherein the stretched container body exhibits a density increase relative to the unstretched container neck of less than 0.03 g/cm³ in the region of the at least one weld seam prior to welding.

5. The container according to claim 1, wherein the container comprises a tube having a tube neck and a tube end opposite the tube neck, wherein the outlet opening is situated in a region of the tube neck and the second opening is situated in a region of the tube end and the second opening is sealed by the weld seam.

6. The container according to claim 1, wherein the container comprises an integral handle formed with a reach-through opening, wherein the weld seam bounds off the reach-through opening by joining a first and second wall end bordering on the reach-through opening.

7. The container according to claim 1, wherein the weld seam has a length of 5 mm and is configured to withstand a tensile force of at least 100 N, the tensile force being oriented substantially perpendicular to the weld seam.

8. The container according to claim 1, wherein the container is comprised of a single layer for easier recycling.

9. The container according to claim 1, wherein the PET or the PEF of the container is bio-based in a proportion of at least 30% or produced from as much as 30% regenerate.

10. The container according to claim 2, wherein the second opening of the container that is closed by forming the weld seam in a temperature range that is above the glass temperature (T_{G}) and below the melting temperature (T_{M}) of the copolymer.

11. A method of manufacturing a plastic container from a preform formed from copolyester, comprising:
stretch blow-molding the preform to form a container having a container body with a container neck attached thereto, the container neck having an outlet opening, wherein walls of the preform are stretched respectively by at least 6 times relative to an unstretched state at least in a region where a weld seam is produced and a density of the walls in a stretched region is increased by at most 0.03 g/cm³,
pressing together the stretched walls, and
welding the stretched walls together to form a weld seam at a welding temperature between a glass transition temperature (T_{G}) and a melting temperature (T_{M}) of the copolyester.

12. The method according to claim 11, further comprising increasing the density of the walls in the region of the weld seam by at most 0.06 g/cm³ due to the welding.

13. The method according to claim 11, further comprising forming an integral handle with a reach-through opening on the container, the weld seam bounding off the reach-through opening by joining together walls bordering on the reach-through opening.

14. The method according to claim 11, further comprising severing or cutting off a portion of the container prior to the pressing together and welding together, thereby producing an opening, the opening closed during the forming of the weld seam at a welding temperature between the glass transition temperature and the melting temperature of the copolyester.

15. The method according to claim 11, wherein a welding time during which the walls are held at welding temperature is between 1 and 6 seconds.

16. The method according to claim 11, further comprising welding the walls together between a first and a second welding jaw, a pressing force against the walls being between 50 and 50000 N/cm2.

17. The method according to claim 16, further comprising opening the welding jaws at a cooldown temperature, the cooldown temperature being below the glass transition temperature.

18. The method according to claim 11, wherein the copolyester is polyethylene terephthalate (PET) having a copolymer content between 4 wt. % and 10 wt. %.

19. The method according to claim 11, wherein the copolyester is polyethylene furanoate (PEF) having a copolymer content below 5 wt. %.

20. The method according to claim 1, further comprising stretch blow-molding the preform in a blow mold for producing a tube, stripping the tube from the mold, cutting off a closed tube end opposite a neck of the tube, the tube configured to be filled with contents through the second opening, and the second opening closed by welding.

21. The method according to claim 11, further comprising producing a junction between stretched walls of the plastic container.

22. A use of a copolyester for production of a preform in order to manufacture a container from the preform in a stretch blow-molding process, wherein the container comprises a container body and a container neck attached thereto, having an outlet opening, and wherein the container has a second opening closed by a weld seam,
the copolyester is polyethylene terephthalate (PET) having a copolymer content between 4 wt. % and 10 wt. %, or
polyethylene furanoate (PEF) having a copolymer content below 5 wt. %.

23. The use according to claim 22, wherein a surface of the container in a region of the weld seam has a stretching ratio relative to the surface of the preform of more than 6:1 and the container body after the welding has a density increase in a region of the weld seam of less than 0.06 g/cm³ relative to the preform body.

24. The use according to claim 22, wherein the copolyester is polyethylene terephthalate (PET) having a copolymer content between 4 wt. % and 10 wt. %, and wherein the copolymer is isophthalic acid, diethylene glycol, furan dicarboxylic acid, propylene glycol, or butylene glycol.

25. The use according to claim 22, wherein the copolyester is polyethylene furanoate (PEF) having a copolymer content below 5 wt. %, and wherein the copolymer is terephthalic acid, isophthalic acid or diethylene glycol, propylene glycol, spiroglycol, or butylene glycol.
